(19) United States
(12) Patent Application Publication
(10) Pub. No.: US 2015/0130922 A1
(43) Pub. Date: May 14, 2015

(54) OBJECTIVE OPTICAL SYSTEM AND IMAGE ACQUISITION APPARATUS

(71) Applicant: CANON KABUSHIKI KAISHA, Tokyo (JP)

(72) Inventors: Kazumasa Tanaka, Saitama-shi (JP); Yasuyuki Unno, Utsunomiya-shi (JP)

(21) Appl. No.: 14/533,261

(22) Filed: Nov. 5, 2014

(30) Foreign Application Priority Data
Nov. 11, 2013 (JP) 2013-232809

(51) Int. Cl. G02B 21/36

(52) U.S. Cl. CPC G02B 21/361
USPC 348/79

(57) ABSTRACT

The objective optical system includes a first optical system configured to collimate a divergent light flux from an object, a second optical system configured to converge the light flux from the first optical system, a beam splitter disposed between the first optical system and the second optical system, a reflector disposed on a side where the light flux from the second optical system is condensed and configured to reflect the light flux, and a third optical system configured to converge the light flux reflected by the reflector and then passing through the second optical system and the beam splitter. When a direction in which the light flux travels in the objective optical system is defined as an optical axis direction, positions of respective portions of the reflector in the optician axis direction are each changeable.

### BACKGROUND OF THE INVENTION

1. Field of the Invention

The present invention relates to an objective optical system suitable to acquire image data of an object such as a pathology specimen and to an image acquisition apparatus including the objective optical system.

2. Description of the Related Art

Image acquisition apparatuses receive attention, each of which captures an image of a pathology specimen (sample) to acquire image data thereof and displays the image data on a display, thereby enabling the image of the pathology specimen to be observed in pathological diagnosis. Using such an image acquisition apparatus enables the image data of the sample, for example, to be simultaneously observed by multiple persons and to be shared with a remote pathologist.

With such an image acquisition apparatus, when a large sample which cannot be included within a visual field of the objective optical system is to be observed, it is necessary to capture the sample multiple times while moving the objective optical system relatively with respect to the sample and then connect multiple obtained image data to produce an image data of the entire sample. In this case, in order to shorten a time to acquire the image data by reducing the number of times of image capturing, an objective optical system having a wide visual field (image capturing area) is required. Furthermore, in observing the sample, an objective optical system is required which has not only such a wide image capturing area, but also a high resolution in a visible light range.

In order to provide a high resolution, it is necessary to increase a numerical aperture (NA) of the objective optical system. Such an increase in NA, however, results in a shallower depth of focus. In addition, when a surface of the sample has concavity and convexity in an optical axis direction of the objective optical system, an optical image of the sample formed by the objective optical system also has concavity and convexity in the optical axis direction. Therefore, when the optical image of the sample is captured through the objective optical system having a high resolution and a wide image capturing area, an out-of-focus portion is likely to occur in the image capturing area.

Japanese Patent Laid-Open No. 2013-044781 discloses an objective optical system in which a deformable mirror is disposed at a position where an object image is formed by a main imaging optical system and which extracts a light reflected by the mirror with a beam splitter disposed between the main imaging optical system and the deformable mirror and then reimages the reflected light on an image pickup plane by using a reimaging optical system.

However, in the objective optical system disclosed in Japanese Patent Laid-Open No. 2013-044781, it is difficult to ensure a space to dispose the beam splitter between the main imaging optical system and the deformable mirror if the main imaging optical system is constituted by an optical system other than a magnifying optical system. In addition, prepared biological samples generally have concavity and convexity with a PV (Peak-to-Valley) value of approximately 10 μm, and an optical image of the surface formed by the magnifying optical system has magnified concavity and convexity in the optical axis direction. For instance, when a magnification of the magnifying optical system is 10 times (10×), the concavity and convexity in the optical image of the sample has a height in the optical axis direction of approximately 1,000 μm.

On the other hand, since conventional deformable mirrors have been used primarily for correcting a wavefront, a deformation amount (maximum stroke) required for them is approximately equivalent to a wavelength (approximately several micrometers). For this reason, extremely a few existing deformable mirrors have a maximum stroke large enough to correct concavity and convexity present in a magnified optical image of a sample. Therefore, a further improvement is necessary for the objective optical system using the deformable mirror in order to be capable of forming an in-focus optical image of the entire sample located within a wide image capturing area and having concavity and convexity.

### SUMMARY OF THE INVENTION

The present invention provides an objective optical system having a high resolution and being capable of forming, in the entire part of a wide image capturing area, an in-focus optical image of an object having concavity and convexity. The present invention further provides an image acquisition apparatus including the objective optical system.

The present invention provides as an aspect thereof an objective optical system configured to form an optical image of an object. The objective optical system includes a first optical system configured to collimate a divergent light flux from the object, a second optical system configured to converge the light flux from the first optical system, a beam splitter disposed between the first optical system and the second optical system, a reflector disposed on a side where the light flux from the second optical system is condensed and configured to reflect the light flux, and a third optical system configured to converge the light flux reflected by the reflector and then passing through the second optical system and the beam splitter. When a direction in which the light flux travels in the objective optical system is defined as an optical axis direction, positions of respective portions of the reflector in the optician axis direction are each changeable.

The present invention provides as another aspect thereof an image acquisition apparatus including an objective optical system configured to form an optical image of an object, an image sensor configured to capture the optical image, and a controller. The objective optical system includes a first optical system configured to collimate a divergent light flux from the object, a second optical system configured to converge the light flux from the first optical system, a beam splitter disposed between the first optical system and the second optical system, a reflector disposed on a side where the light flux from the second optical system is condensed and configured to reflect the light flux, and a third optical system configured to converge the light flux reflected by the reflector and passing through the second optical system and the beam splitter. When a direction in which the light flux travels in the objective optical system is defined as an optical axis direction, positions of respective portions of the reflector in the optician axis direction are each changeable. The controller is configured to control the positions of the respective portions of the reflector in the optical axis direction.

The present invention provides as still another aspect thereof an objective optical system configured to form an optical image of an object. The objective optical system includes a first imaging optical system configured to image a light flux from the object, a second imaging optical system configured to reimage the light flux imaged by the first imaging optical system, and a reflector configured to reflect the light flux from the first imaging optical system to direct the light flux toward the second imaging optical system. When a direction in which the light flux travels in the objective optical system is defined as an optical axis direction, the position of respective portions of the reflector in the optical axis direction are each changeable, and the following condition is satisfied:

M≦√(2×Δzm/Δzo)

where M represents a magnification of the first imaging optical system, Δzm represents a maximum distance in the optical axis direction settable between the portions of the reflector, and Δzo represents a maximum distance between portions of a surface of the object which are apart from each other in the optical axis direction.

Other aspects of the present invention will become apparent from the following description and the attached drawings.

### BRIEF DESCRIPTION OF THE DRAWINGS

FIG. 1 is a schematic diagram of an image acquisition system that is Embodiment 1 of the present invention.

FIGS. 2A and 2B are schematic diagrams illustrating a positional relation between an imaging point of a first imaging optical system and a reflective surface of a reflector in Embodiment 1.

FIGS. 3A and 3B are diagrams illustrating a simulation result of Embodiment 1.

FIG. 4 is a schematic diagram of main elements of an image acquisition apparatus that is Embodiment 2 of the present invention.

FIG. 5 is a schematic diagram of main elements of an image acquisition apparatus that is Embodiment 3 of the present invention.

### DESCRIPTION OF THE EMBODIMENTS

Exemplary embodiments of the present invention will be described below with reference to the attached drawings.

### Embodiment 1

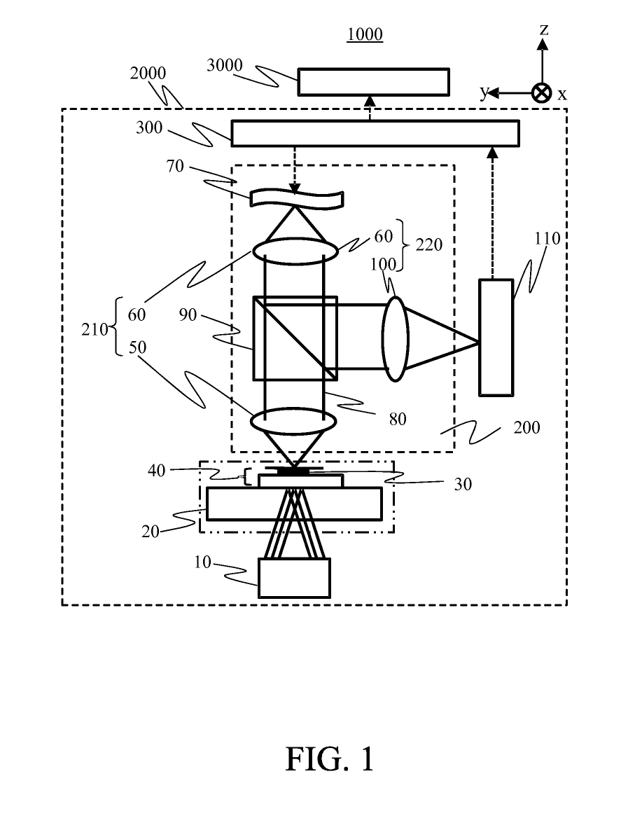

FIG. 1 illustrates a configuration of an image acquisition system 1000 including an image acquisition apparatus 2000 that is a first embodiment (Embodiment 1) of the present invention. The image acquisition apparatus 2000 captures, by using an image sensor 110, an optical image of a sample 30 as an object formed by an objective optical system 200 to acquire an image (data) of the sample 30. The image acquisition system 1000 displays the acquired image on an image display unit 3000.

The objective optical system 200 includes a first optical system 50 which converts a divergent light flux from each point of the sample 30 into a collimated light flux or approximates the divergent light flux to the collimated light flux (hereinafter collectively referred to as “collimate the divergent light flux”) and a second optical system 60 which converges the light flux exiting from the first optical system 50. The first optical system 50 and the second optical system 60 constitute a first imaging optical system 210. In addition, the objective optical system 200 includes a reflector 70 disposed within a predetermined range including a light-condensed position at which the light flux is condensed by the second optical system 60 and a beam splitter 90 disposed in a collimated light path 80 located between the first optical system 50 and the second optical system 60. In this embodiment, the reflector 70 is a deformable mirror. The deformable mirror has, behind its reflective surface, multiple electrodes and piezoelectric elements, and a shape of the reflective surface is controllable by controlling amounts of electricity applied to the electrodes or the piezoelectric elements.

The objective optical system 200 further includes a third optical system 100 which converges and reimages the light flux reflected by the reflector 70, exiting again from the second optical system 60 and then reflected by the beam splitter 90 to be directed toward the third optical system 100. The second optical system 60 and the third optical system 100 constitute a second imaging optical system 220. The beam splitter 90 is disposed between the reflector 70 and a reimaging position of the second imaging optical system 220.

In the following description, a direction in which the light travels in the objective optical system 200 is referred to as “an optical axis direction”, and a central axis of each of the first, second and third optical systems along the optical axis direction is referred to as “an optical axis” of each optical system.

The reflector 70 is a reflective member in which positions of respective portions of its reflective surface in the optical axis direction is changeable, in other words, in which local positions of the reflective surface in the optical axis direction is changeable. Each portion of the reflective surface of the reflector 70 whose position in the optical axis direction is changeable is hereinafter referred to as “a reflective surface portion”.

Next, description will be made of processes by which the image acquisition apparatus 2000 of this embodiment acquires an image. In FIG. 1 and other drawings, a z axis is located in a direction along the optical axis of the first optical system 50, and an x axis is located in a direction vertical to a plane of each drawing. A y axis is located in a direction which is orthogonal to the z and x axes and in which a right screw moves when the right screw is turned from the z axis toward the x axis.

First, a preparation 40 including the sample 30 is held on an image capturing stage 20. Thereafter, an illumination light from a light source (not illustrated) enters an illumination optical system 10 and then exits therefrom, evenly illuminating the preparation 40. As the illumination light from the light source, a visible light having a wavelength of, for example, 400 nm to 700 nm can be used.

The light flux emitted from the sample 30 in the preparation 40 enters the objective optical system 200. The divergent light flux emitted from each of respective points of the sample 30 is collimated by the first optical system 50. The collimated light flux is transmitted through the beam splitter 90 disposed in the collimated light path 80 and then converged by the second optical system 60 to form an optical image of the sample 30 near the reflector 70. The term “near the reflector 70” used herein means that a distance to the reflector 70 is equal to or less than a value obtained by multiplying a height of concavity and convexity of the sample 30 by a longitudinal magnification of the optical system imaging the light flux from the sample 30.

The light reflected by the reflector 70 again enters the second optical system 60 and is then collimated. Thereafter, the collimated light flux is reflected by the beam splitter 90 such that its traveling direction is changed to a direction orthogonal to the optical axis of the first optical system 50, enters the third optical system 100 to be converged by the third optical system 100 and then reimaged near an image pickup plane of the image sensor 110. As described above, the optical axis of the first optical system 50 and the optical axis of the third optical system 100 are not parallel to each other.

Next, description will be made of a method of forming, by controlling the shape (that is, the positions of the reflective surface portion in the optical axis direction) of the reflector 70 when the sample 30 has the concavity and convexity in the z axis direction, an even (flat) optical image on the image pickup plane of the image sensor 110.

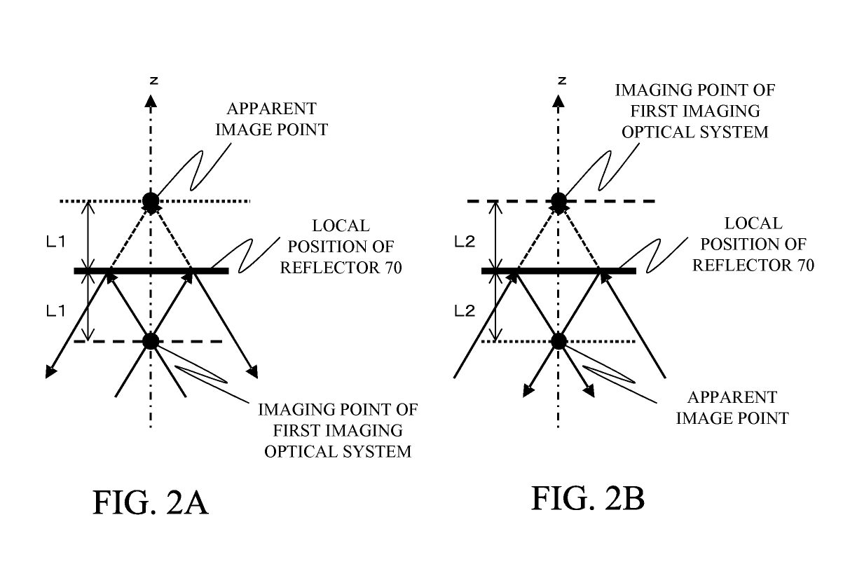

FIGS. 2A and 2B schematically illustrate a positional relation between an imaging point of the first imaging optical system 210 constituted by the first and second optical systems 50 and 60 and the reflective surface portion of the reflector 70 (shown as “LOCAL POSITION OF REFLECTOR 70” in the figures) in the optical axis direction. As illustrated in FIG. 2A, when the reflective surface portion is disposed at a position away from the imaging point of the first imaging optical system 210 by a distance L1 toward a rearward direction (+z direction), the light flux is reflected by the reflective surface portion and forms an apparent image point at a position away from the reflective surface portion by the distance L1 toward the rearward direction. Similarly, as illustrated in FIG. 2B, when the reflective surface portion is disposed at a position away from the imaging point of the first imaging optical system 210 by a distance L2 toward a forward direction (−z direction), the light flux is reflected by the reflective surface portion and then forms the apparent image point at a position away from the reflective surface portion by the distance L2 toward the forward direction.

In order to provide an in-focus image in an entire part of an image capturing area corresponding to a visual field of the objective optical system 200, it is necessary to make an imaging plane of the second imaging optical system 220 constituted by the second optical system 60 and the third optical system 100 coincide with an image pickup plane of the image sensor 110. To achieve this, it is enough, by regarding a position of the image pickup plane of the image sensor 110 as a position of the image surface (hereinafter referred to as “a second image surface”) of the second optical system 220, to make a position conjugate thereto (that is, an object position of the second optical system 220) coincide with a position of the image surface (hereinafter referred to as “a first image surface”) of the first imaging optical system 210.

When the shape of the sample 30 has the concavity and convexity in the z direction, the position of the imaging point (each point on the first image surface) of the first imaging optical system 210 varies depending on position in the image capturing area, so that the position of the imaging point is not located on one plane. However, in this embodiment, taking advantage of the positional relation illustrated in FIGS. 2A and 2B, each reflective surface portion of the reflector 70 is disposed at an intermediate position between the position of each imaging point of the first imaging optical system 210 and a position of each object point of the second imaging optical system 220. This enables making the object position of the second imaging optical system 220 coincide with a position of an apparent image surface of the first imaging optical system 210. This consequently makes it possible to make the position of the image surface of the second imaging optical system 220 corresponds to the image pickup plane of the image sensor 110, which enables forming an in-focus image in the entire part of the wide image capturing area.

However, as described above, since a few existing deformable mirrors have a maximum stroke in the z axis direction greater than a wavelength scale of light, there is an upper limit of a deformation amount of the reflector 70 in the z axis direction that can be achieved with existing techniques.

A PV (Peak-to-Valley) value of concavity and convexity of the first image surface in the z direction is represented by Δzi, and the PV value of the concavity and convexity of the object in the image capturing area, namely, a maximum distance between portions of a surface of the object (object surface) apart from each other in the z direction is represented by Δzo. The PV value Δzi is expressed by following expression (1) using the PV value Δzo and a magnification M₁ of the first imaging optical system 210:

Δzi=M₁²×Δzo (1)

Because of a relation that the deformation amount of the reflector 70 is a half of a height of the concavity and convexity of the first image surface in the z direction, the upper limit of the deformation amount of the reflector 70 provides a permissible upper limit of the PV value Δzi of the concavity and convexity of the first image surface. When a maximum distance in the z direction settable to different reflective surface portions of the reflector 70 by its deformation is represented by a maximum stroke Δzm of the reflector 70, there is a restrictive condition expressed by following expression (2):

Δzi/2≦√Δzm (2)

From expression (1), when the magnification M₁ of the first imaging optical system 210 satisfies a condition expressed by the following expression (3), the condition of expression (2) is satisfied.

M₁≦√(2×Δzm/Δzo) (3)

When the object is a sample included in a preparation, the PV value Δzo thereof is, in general, approximately 10 μm. On the other hand, the maximum stroke Δzm of the existing deformable mirrors is 100 μm or shorter. Therefore, from a calculation in which these values are substituted into expression (3), it is desirable that the magnification M₁ of the first imaging optical system 210 is equal to or smaller than 5 times (5×).

Since the objective optical system 200 of this embodiment has a configuration in which the beam splitter 90 is disposed in the collimated light path 80 between the first and second optical systems 50 and 60, the magnification of the first imaging optical system 210 can be set to be low. This setting makes it possible to satisfy the condition of expression (3), which enables using the existing deformable mirror as the reflector 70 to correct the concavity and convexity of the image surface.

The light reflected by the reflector 70 is, as required, magnified and imaged by the second imaging optical system 220. Use of the configuration of this embodiment enables selection of the magnifications of the first and second imaging optical systems 210 and 220 such that the magnifications meet conditions such as an area of the reflective surface of and the maximum stroke of the reflector 70 to be used and a pixel pitch of the image sensor 110.

In order to suppress generation of aberration and distortion due to the deformation of the reflector 70, it is desirable that the second optical system 60 is an optical system telecentric on its reflector side where the reflector 70 is disposed.

An appropriate deformation amount of the reflector 70 to make the above-described second image surface even is decided and controlled by an image processer/controller 300 on a basis of variation in contrast of the image acquired by the image sensor 110, namely, a focus state of the optical image with respect to the deformation of the reflector 70.

In addition, a defocus (offset component) generated uniformly in the entire image capturing area may be eliminated by moving the image capturing stage or the image sensor 110 in the optical axis direction to perform focusing.

In order to suppress generation of aberration and distortion due to the movement of the image capturing stage 20 or the image sensor 110 in the optical axis direction, it is desirable that the first optical system 50 is an optical system telecentric on its object side and that the third optical system 100 is an optical system telecentric on its image side.

The above-described configuration enables forming an in-focus optical image on the image pickup plane of the image sensor 110 in the entire image capturing area.

A result of a simulation of image capturing of an object having concavity and convexity in the z direction in the image capturing area by using the objective optical system 200 of this embodiment will be described. A shape of an object surface in the z direction assumed in this simulation is a quadric surface shape expressed by an expression dependent on an x coordinate, such as z=a×x² (letter “a” represents a constant). The PV value of the object surface in the z direction is 10 μm. In addition, in this simulation, the first optical system 50, the second optical system 60 and the third optical system 100 are each assumed as an ideal lens which generates no aberration. The magnification M₁ of the first imaging optical system 210 is set to lx, a magnification M₂ of the second imaging optical system 220 is set to 10×, and an object side NA is set to 0.7. With a total of twenty one points on the object (object points) being located along the x direction at a certain y coordinate, light rays emitted from the respective object points are traced to evaluate an image performance. In addition, object-point numbers are allocated, in order from a −x direction to a +x direction, to the twenty one object points at which the ray tracing is performed.

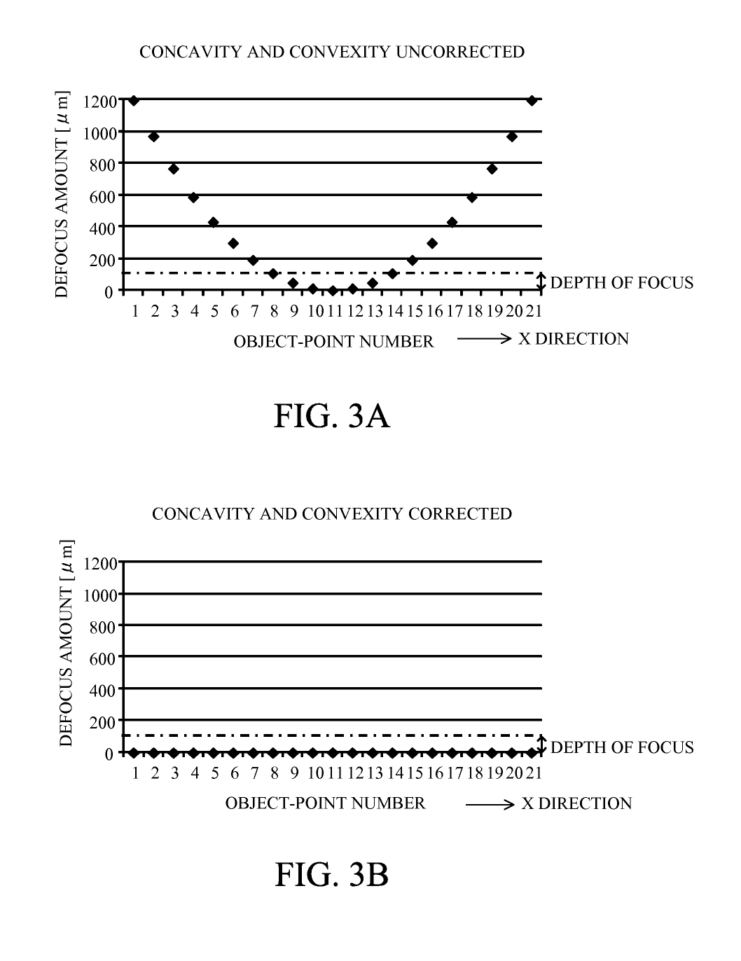

FIG. 3A is a graph showing amounts of defocus generated when a light flux from the object surface assumed as described above is imaged by an objective optical system whose magnification is 10× and which do not have a function of correcting the concavity and convexity of the image surface by the reflector 70. Numbers 1 to 21 on a horizontal axis of the graph represent the above-described object-point numbers. A vertical axis of the graph indicates a distance between an imaging position of the light flux emitted from each object point and the image pickup plane; the distance corresponds to the defocus amount. Since the object surface is the quadric surface, the imaging points of the object points are also distributed in a quadric surface shape. When the NA is 0.7 of this objective optical system and a reference wavelength A is 587.6 nm, a depth of focus d is calculated to be approximately 120 μm by using following expression (4):

d=λ/[NA/(M₁×M₂)]² (4)

Therefore, an optical image corresponding to FIG. 3A has largely-out-of-focus portions.

FIG. 3B is a graph showing amounts of defocus generated when a light flux from the object surface assumed as described above is imaged by the objective optical system 200 of this embodiment. Similarly to FIG. 3A, numbers 1 to 21 on a horizontal axis of the graph represent object-point numbers and a vertical axis thereof indicates the defocus amount. A depth of focus of the objective optical system 200 is approximately 120 μm similarly to the case illustrated in FIG. 3A and the quadric-surface-like defocus generated in the case illustrated in FIG. 3A is corrected to approximately zero as illustrated in FIG. 3B. In addition, the deformation amount of the reflector 70 in the z direction is 5 μm at maximum; such a deformation amount can be realized in the existing deformable mirrors.

This simulation is performed with the assumption that the first, second and third optical systems 50, 60 and 100 are each the ideal lens. However, the configuration of this embodiment enables providing a concavity/convexity correction effect (optical image defocus correction effect) of an equivalent level to the result of the simulation.

The optical image of the sample 30 formed on the image pickup plane of the image sensor 110 is captured by the image sensor 110. Then, the image processer/controller 300 performs an image capturing process on image capturing information output from the image sensor 110 to produce an image data. The image data is displayed on the image display unit 3000. Thus, an in-focus image of the sample 30 captured in the entire image capturing area can be provided and observed.

In addition, the image processer/controller 300 performs various processes such as an image process for correcting aberration which could not be corrected by the objective optical system 200 and a connecting process for connecting multiple image data to produce one image data.

### Embodiment 2

Although Embodiment 1 decides the deformation amount of the reflector 70 on the basis of the variation in focus state of the optical image with respect to the deformation of the reflector 70, a second embodiment (Embodiment 2) of the present invention determines the deformation amount of the reflector 70 on a basis of a premeasured shape of an object.

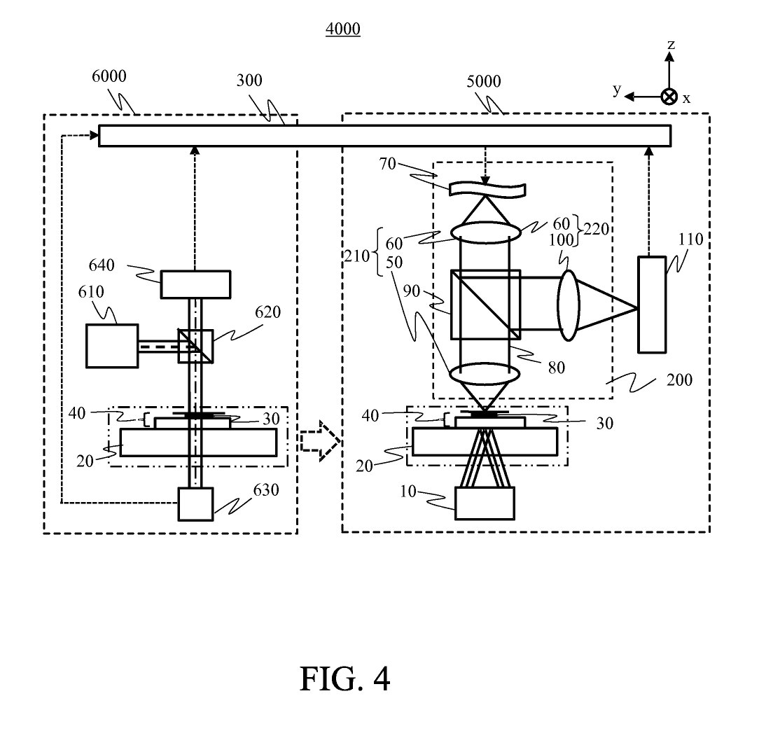

FIG. 4 illustrates a configuration of an image acquisition system 4000 including an image acquisition apparatus 5000 of Embodiment 2. The image acquisition system 4000 includes the image acquisition apparatus 5000 including an objective optical system 200, and an auxiliary measurer 6000.

First, an image capturing stage 20 on which a preparation 40 including a sample 30 is placed is provided to the auxiliary measurer 6000. Then, a light flux from an auxiliary-measurement light source 610 is deflected by an auxiliary-measurement beam splitter 620, illuminating the preparation 40.

Of the light flux illuminating the sample 30, a light flux transmitted through the preparation 40 enters an x/y-position measuring sensor 630. The sensor 630 measures the sample 30 included in the preparation 40 to acquire data of its size, its position in x and y directions and the like and sends the measured data to an image processer/controller 300. As the x/y-position measuring sensor 630, a CCD camera or the like can be used.

On the other hand, a light flux reflected by the preparation 40 is transmitted through the auxiliary-measurement beam splitter 620 and then enters a z-shape measuring sensor 640. The sensor 640 measures positions (shape) in a z direction at respective x and y positions of the sample 30 included in the preparation 40 and sends the measured data to the image processor/controller 300. As the z-shape measurement unit 640, a Shack-Hartmann sensor or the like can be used.

The image processor/controller 300 stores the auxiliary-measured data of the preparation 40 (the position in the x and y directions, the size and the shape in the z direction of the sample 30) sent from the x/y-position and z-shape measuring sensors 630 and 640 to a memory.

The auxiliary measurer 6000 may have other configurations that that described above. For example, the auxiliary measurer 6000 may measure the position in x and y directions and the shape in the z direction at another position by using another light source.

After completion of the auxiliary measurement, the image capturing stage 20 holding the preparation 40 moves from the auxiliary measurer 6000 to the image acquisition apparatus 5000.

In the image acquisition apparatus 5000, similarly to the image acquisition apparatus 2000 described in Embodiment 1, an illumination light from a light source passes through the illumination optical system 10 and then illuminates the sample 30. Of the illumination light, light fluxes emitted from respective points of the sample 30 pass through the objective optical system 200 to form an optical image on the image pickup plane of the image sensor 110.

In this embodiment, an appropriate deformation amount of the reflector 70 to make the image surface formed on the image pickup plane of the image sensor 110 even is decided by the image processor/controller 300 on a basis of a concavo-convex shape of the sample 30 acquired by the auxiliary measurement. A shape fm(x,y) of the reflector 70 in the z direction is given by following expression (5) from the concavo-convex shape of the sample 30 in the z direction and the magnification M₁ of the first imaging optical system 210 constituted by the first optical system 50 and the second optical system 60.

fm(x, y)=(M₁²/2)×fo(x, y) (5)

The reflected light from the reflector 70 thus deformed, similarly to that of Embodiment 1, passes through a second imaging optical system 220 constituted by the second optical system 60 and a third optical system 100 to form an even optical image on the image pickup plane of the image sensor 110.

Moreover, similarly to Embodiment 1, also in this embodiment, imposing the restriction represented by expression (3) on the magnification M₁ of the first imaging optical system 210 makes it possible to use an existing deformable mirror to correct the concavity and convexity of the image surface.

Also in this embodiment, an in-focus image of the sample 30 captured in the entire image capturing area can be provided and observed.

### Embodiment 3

Although each of Embodiments 1 and 2 illuminates the sample 30 by transmission illumination to form the optical image of the sample 30, a third embodiment (Embodiment 3) of the present invention illuminates the sample 30 by epi-illumination to form an optical image of the sample 30. This embodiment is suitable for fluorescent observation of a biological sample or the like.

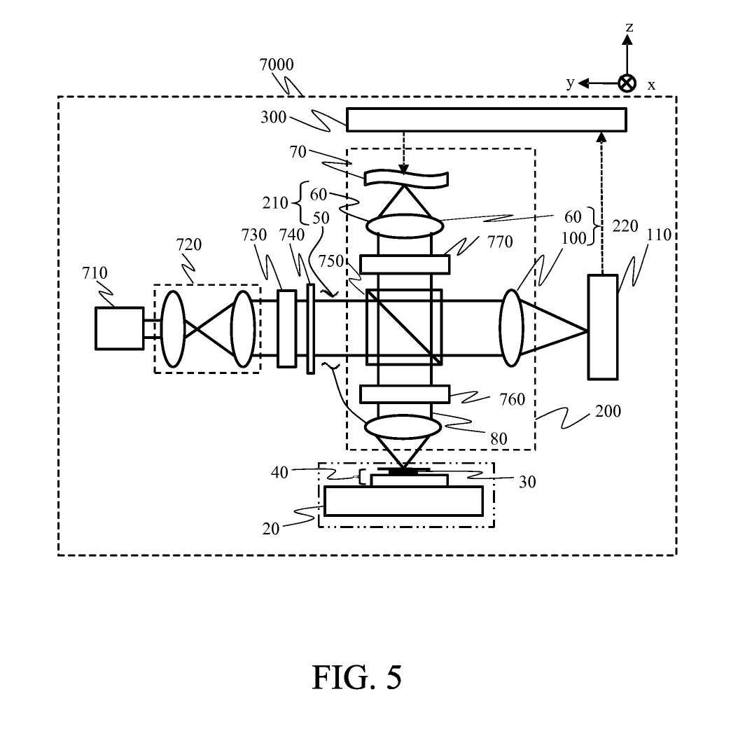

FIG. 5 illustrates a configuration of an image acquisition apparatus 7000 of Embodiment 3. An illumination light emitted from an epi-illumination light source 710 is converted by a beam collimator 720 into a collimated light flux having a predetermined diameter. The diameter of the collimated light flux is adjusted so as to be, for example, same as that of a light flux traveling in the collimated light path 80. As the epi-illumination light source 710, a solid-state laser or the like can be used.

The illumination light exiting from the beam collimator 720 is converted by a wave plate 730 and a polarizing plate 740 into an s-polarized light and then reaches a polarization beam splitter 750. The s-polarized light is reflected by the polarization beam splitter 750 in a −z direction, passes through a first optical system 50 and then illuminates the sample 30.

Part of the light scattered by the sample 30 enters the first optical system 50 and is then collimated.

A p-polarized light transmitted through the polarization beam splitter 750 is observed. A transmittance of the polarization beam splitter 750 for the p-polarized light in the observation is, as required, adjusted by increasing the p-polarized light by a second wave plate 760. This adjustment can be performed by, for example, inserting an adjusting polarization beam splitter (not illustrated) between the second wave plate 760 and the polarization beam splitter 750 to measure an intensity of the reflected light.

The light transmitted through the polarization beam splitter 750 passes through a λ/4-wave plate 770 and passes through the second optical system 60 to form an optical image of the sample 30 near the reflector 70.

Similarly to Embodiment 1, the reflector 70 is deformed such that the reflected light from the reflector 70 forms an even optical image on the image pickup plane of the image sensor 110. In addition, similarly to Embodiment 1, imposing the restriction represented by expression (3) on the magnification M₁ of the first imaging optical system 210 constituted by the first optical system 50 and the second optical system 60 makes it possible, also in this embodiment, to use an existing deformable mirror to correct the concavity and convexity of the image surface.

The reflected light from the reflector 70 is again collimated by the second optical system 60 and then converted into an s-polarized light by passing through the λ/4-wave plate 770. The s-polarized light is reflected by the polarization beam splitter 750 in a −y direction, passes through the third optical system 100 and then forms an even optical image on the image pickup plane of the image sensor 110. Also in this embodiment, the second optical system 60 and the third optical system 100 constitute the second imaging optical system 220.

With the above-described configuration, even when the sample 30 is illuminated by the epi-illumination by using the polarization beam splitter 750, an in-focus image of the sample 30 captured in the entire image capturing area can be provided and observed.

### MODIFIED EXAMPLES

A combination of Embodiments 2 and 3 described above makes it possible to perform epi-illumination as illumination in the image acquisition apparatus 5000.

Moreover, in order to shorten a time required to acquire the image data, the image acquisition apparatus of each embodiment may include multiple objective optical systems 200.

Furthermore, driving the image capturing stage 20 in the x and y directions enables acquiring the image date of the sample 30 in a broad area.

Moreover, although each of the above embodiments described the case where the optical axis of the first optical system 50 and the optical axis of the second optical system 60 are parallel to each other, a configuration may alternatively be employed in which the optical axis of the first optical system 50 and the optical axis of the second optical system 60 are orthogonal to each other and the optical axis of the second optical system 60 and the optical axis of the third optical system 100 are parallel to each other.

In addition, instead of the deformable mirror, a tiltable planar mirror may be used as a reflector 70 whose positions of respective portions in the optical axis direction are changeable. In this case, an image capturing area where an in-focus optical image can be simultaneously formed is narrowed, depending on the concavo-convex shape of the sample 30, as compared to the case where the deformable mirror is used. However, the maximum stroke Δzm of the reflector 70 can be increased as compared to the case where the existing deformable mirror is used.

Each of the above-described embodiments can realize an objective optical system which uses a reflector such as a deformable mirror, has a high resolution and is capable of, in an entire wide image capturing area, forming an in-focus optical image of an object having concavity and convexity. Using the image acquisition apparatus including such an objective optical system can provide a high-resolution image data of the object in a short period of time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-232809, filed on Nov. 11, 2013, which is hereby incorporated by reference herein in its entirety.

What is claimed is:

1. An objective optical system configured to form an optical image of an object, the objective optical system comprising:
a first optical system configured to collimate a divergent light flux from the object;
a second optical system configured to converge the light flux from the first optical system;
a beam splitter disposed between the first optical system and the second optical system;
a reflector disposed on a side where the light flux from the second optical system is condensed and configured to reflect the light flux; and
a third optical system configured to converge the light flux reflected by the reflector and then passing through the second optical system and the beam splitter,
wherein, when a direction in which the light flux travels in the objective optical system is defined as an optical axis direction, positions of respective portions of the reflector in the optician axis direction are each changeable.

2. An objective optical system according to claim 1, wherein the reflector is disposed in a predetermined range including a position at which the light flux from the second optical system is condensed.

3. An objective optical system according to claim 1, wherein the reflector is deformable such that the positions of the respective portions thereof in the optical axis direction are each changeable.

4. An objective optical system according to claim 1, wherein the following condition is satisfied:
M≦√(2×Δzm/Δzo)
where M represents a magnification of a first imaging optical system constituted by the first and second optical systems, Δzm represents a maximum distance in the optical axis direction settable between the portions of the reflector, and Δzo represents a maximum distance between portions of a surface of the object which are apart from each other in the optical axis direction.

5. An image acquisition apparatus comprising:
an objective optical system configured to form an optical image of an object;
an image sensor configured to capture the optical image; and
a controller,
wherein the objective optical system includes:
a first optical system configured to collimate a divergent light flux from the object,
a second optical system configured to converge the light flux from the first optical system,
a beam splitter disposed between the first optical system and the second optical system,
a reflector disposed on a side where the light flux from the second optical system is condensed and configured to reflect the light flux, and
a third optical system configured to converge the light flux reflected by the reflector and passing through the second optical system and the beam splitter;
wherein, when a direction in which the light flux travels in the objective optical system is defined as an optical axis direction, positions of respective portions of the reflector in the optician axis direction are each changeable, and
wherein the controller is configured to control the positions of the respective portions of the reflector in the optical axis direction.

6. An image acquisition apparatus according to claim 5, wherein the controller is configured to control the positions of the respective portions of the reflector in the optical axis direction depending on a focus state of the optical image.

7. An image acquisition apparatus according to claim 5, further comprising a measurer configured to acquire shape information on a shape of the object,
wherein the controller is configured to control the positions of the respective portions of the reflector in the optical axis direction on a basis of the shape information.

8. An image acquisition apparatus according to claim 5, wherein an illumination light which illuminates the object reaches the object through the beam splitter.

9. An objective optical system configured to form an optical image of an object, the objective optical system comprising:
a first imaging optical system configured to image a light flux from the object;
a second imaging optical system configured to reimage the light flux imaged by the first imaging optical system; and
a reflector configured to reflect the light flux from the first imaging optical system to direct the light flux toward the second imaging optical system,
wherein, when a direction in which the light flux travels in the objective optical system is defined as an optical axis direction,
the position of respective portions of the reflector in the optical axis direction are each changeable, and
the following condition is satisfied:
M≦√(2×Δzm/Δzo)
where M represents a magnification of the first imaging optical system, Δzm represents a maximum distance in the optical axis direction settable between the portions of the reflector, and Δzo represents a maximum distance between portions of a surface of the object which are apart from each other in the optical axis direction.

10. An objective optical system according to claim 9, wherein the magnification of the first imaging optical system is equal to or smaller than 5 times.

11. An objective optical system according to claim 9, wherein the reflector is disposed in a predetermined range including a position at which the light flux from the first imaging optical system is condensed.

12. An objective optical system according to claim 9, wherein the reflector is deformable such that the positions of the respective portions of the reflector in the optical axis direction are each changeable.

13. An objective optical system according to claim 9, further comprising a beam splitter disposed between the reflector and a reimaging position of the second imaging optical system.

14. An objective optical system according to claim 9, wherein the second imaging optical system is a magnifying optical system.

15. An objective optical system according to claim 9,
wherein:
the first imaging optical system includes a first optical system configured to collimate a divergent light flux from the object, a second optical system configured to converge the light flux from the first optical system and a beam splitter disposed between first and second optical systems, and
the second imaging optical system includes the second optical system and a third optical system configured to converge the light flux reflected by the reflector and then passing through the second optical system and the beam splitter.

16. An objective optical system according to claim 15, wherein an optical axis of the first optical system and an optical axis of the third optical system are not parallel to each other.
